(19) United States
(12) Patent Application Publication
(10) Pub. No.: US 2022/0334760 A1
(43) Pub. Date: Oct. 20, 2022

(54) STORAGE DEVICE AND METHOD OF OPERATING THE SAME

(71) Applicant: SK hynix Inc., Gyeonggi-do (KR)

(72) Inventor: Jae Youn JANG, Gyeonggi-do (KR)

(21) Appl. No.: 17/495,443

(22) Filed: Oct. 6, 2021

(30) Foreign Application Priority Data
Apr. 14, 2021 (KR) 10-2021-0048630

(51) Int. Cl. G06F 3/06

(52) U.S. Cl. CPC G06F 3/0656; G06F 3/0625; G06F 3/0679

(57) ABSTRACT

The present technology relates to an electronic device. A storage device may include a memory device and a memory controller. The memory device may include a buffer block and a plurality of zones each having a plurality of data blocks. The memory controller may control the memory device to: flush target data of write data to the buffer block, a write operation of the write data on a first zone is interrupted due to a sudden power off, and copy data previously stored in the first zone, among the write data, to a second zone and the target data flushed into the buffer block to the second zone after the sudden power off is recovered. The data previously stored in the first zone and the target data correspond to consecutive logical addresses.

### CROSS-REFERENCE TO RELATED APPLICATION

The present application claims priority under 35 U.S.C. § 119(a) to Korean patent application number 10-2021-0048630 filed on Apr. 14, 2021, the entire disclosure of which is incorporated by reference herein.

### BACKGROUND

### Field of Invention

The present disclosure relates to an electronic device, and more particularly, to a storage device and a method of operating the same.

### Description of Related Art

A storage device is a device that stores data under control of a host device such as a computer or a smartphone. A storage device may include a memory device in which data is stored and a memory controller controlling the memory device. The memory device is divided into a volatile memory device and a nonvolatile memory device.

The volatile memory device is a device that stores data only when power is supplied and loses the stored data when the power supply is cut off. The volatile memory device includes a static random access memory (SRAM), a dynamic random access memory (DRAM), and the like.

The nonvolatile memory device is a device that does not lose data even though power is cut off. The nonvolatile memory device includes a read only memory (ROM), a programmable ROM (PROM), an electrically programmable ROM (EPROM), an electrically erasable and programmable ROM (EEPROM), a flash memory, and the like.

### SUMMARY

An embodiment of the present disclosure provides a storage device having improved storage area management performance, and a method of operating the same.

According to an embodiment of the present disclosure, a storage device may include a memory device and a memory controller. The memory device may include a buffer block and a plurality of zones each having a plurality of data blocks. The memory controller may control the memory device to: flush write data corresponding to a write operation to the buffer block when the write operation performed on a first zone among the plurality of zones is stopped due to a sudden power off, and perform a sudden power off recovery operation of copying data stored in the first zone to a second zone among the plurality of zones after the power supply is restored. In the sudden power off recovery operation, the memory controller controls the memory device to: copy data stored in a source block on which the write operation is stopped among the data blocks within the first zone to a target block among the data blocks within the second zone, and copy the write data, which is flushed to the buffer block, to the target block.

According to an embodiment of the present disclosure, a method of operating a storage device including a buffer block and a plurality of zones each having a plurality of data blocks comprises: sensing a sudden power off in which a power supply is abnormally cut off, flushing write data corresponding to a write operation to the buffer block when the write operation performed on a first zone among the plurality of zones is stopped due to the sudden power off, and performing a sudden power off recovery operation of copying data stored in the first zone to a second zone among the plurality of zones after the power supply is restored. The performing the sudden power off recovery operation comprises: copying data stored in a source block on which the write operation is stopped among the data blocks within the first zone to a target block among the data blocks within the second zone, and copying the write data, which is flushed to the buffer block, to the target block.

According to an embodiment of the present disclosure, a method of operating a storage device comprises: flushing target data from a write buffer to a buffer block, a write operation to store the target data into a first block being interrupted due to a sudden power off, and moving, when powered on after the sudden power off, stored data from the first block to a second block and then the flushed target data from the buffer block to the second block. The stored data and the target data correspond to consecutive logical addresses.

According to the present technology, the storage device having improved storage area management performance, and the method of operating the same are provided.

### BRIEF DESCRIPTION OF THE DRAWINGS

FIG. 1 is a diagram illustrating a storage device according to an embodiment of the present disclosure.

FIG. 2 is a diagram illustrating a structure of a memory device of FIG. 1 according to an embodiment of the present disclosure.

FIG. 3 is a diagram illustrating a memory cell array of FIG. 2 according to an embodiment of the present disclosure.

FIG. 4 is a diagram illustrating a method in which one memory controller controls a plurality of memory devices according to an embodiment of the present disclosure.

FIG. 5 is a diagram illustrating a zone in which sequential writing is performed according to an embodiment of the present disclosure.

FIG. 6 is a diagram illustrating a sudden power off recovery operation according to an embodiment of the present disclosure.

FIG. 7 is a flowchart illustrating an operation of a storage device according to an embodiment of the present disclosure.

FIG. 8 is a flowchart illustrating in detail the operation of the storage device described with reference to FIG. 7 according to an embodiment of the present disclosure.

FIG. 9 is a diagram illustrating another embodiment of the present disclosure of the memory controller of FIG. 1.

FIG. 10 is a block diagram illustrating a memory card system to which a storage device according to an embodiment of the present disclosure, is applied.

FIG. 11 is a block diagram illustrating a solid state drive (SSD) system to which a storage device according to an embodiment of the present disclosure is applied.

FIG. 12 is a block diagram illustrating a user system to which a storage device according to an embodiment of the present disclosure, is applied.

### DETAILED DESCRIPTION

Specific structural or functional descriptions of embodiments according to the concept which are disclosed in the present specification are illustrated only to describe the embodiments according to the concept of the present disclosure. The embodiments according to the concept of the present disclosure may be carried out in various forms and should not be construed as being limited to the embodiments described in the present specification.

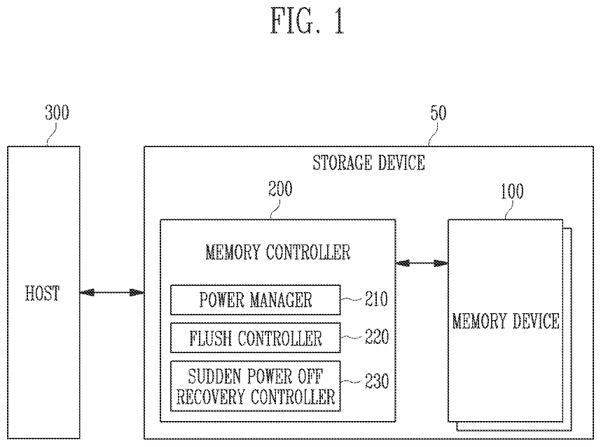

FIG. 1 is a diagram illustrating a storage device according to an embodiment of the present disclosure.

Referring to FIG. 1, the storage device 50 may include a memory device 100 and a memory controller 200 that controls an operation of the memory device 100. The storage device 50 is a device that stores therein data under control of a host 300 such as a cellular phone, a smartphone, an MP3 player, a laptop computer, a desktop computer, a game player, a TV, a tablet PC, or an in-vehicle infotainment system.

The storage device 50 may be manufactured as one of various types of storage devices according to a host interface that is a communication method with the host 300. For example, the storage device 50 may be configured as any of various types of storage devices such as an SSD, a multimedia card in a form of an MMC, an eMMC, an RS-MMC and a micro-MMC, a secure digital card in a form of an SD, a mini-SD and a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-e or PCIe) card type storage device, a compact flash (CF) card, a smart media card, and a memory stick.

The storage device 50 may be manufactured as any of various types of packages. For example, the storage device 50 may be manufactured as any of various types of package types, such as a package on package (POP), a system in package (SIP), a system on chip (SOC), a multi-chip package (MCP), a chip on board (COB), a wafer-level fabricated package (WFP), and a wafer-level stack package (WSP).

The memory device 100 may store data therein. The memory device 100 operates under control of the memory controller 200. The memory device 100 may include a memory cell array including a plurality of memory cells that store data.

Each of the memory cells may be configured as a single level cell (SLC) storing one data bit, a multi-level cell (MLC) storing two data bits, a triple level cell (TLC) storing three data bits, or a quad level cell (QLC) storing four data bits.

The memory cell array may include a plurality of memory blocks. Each memory block may include a plurality of memory cells. One memory block may include a plurality of pages. In an embodiment, the page may be a unit for storing data in the memory device 100 or reading data stored in the memory device 100.

The memory block may be a unit for erasing data. In an embodiment, the memory device 100 may be a double data rate synchronous dynamic random access memory (DDR SDRAM), a low power double data rate4 (LPDDR4) SDRAM, a graphics double data rate (DDDR) SDRAM, a low power DDR (LPDDR), a Rambus dynamic random access memory (RDRAM), a NAND flash memory, a vertical NAND flash memory, a NOR flash memory, a resistive random access memory (RRAM), a phase-change random access memory (PRAM), a magnetoresistive random access memory (MRAM), a ferroelectric random access memory (FRAM), a spin transfer torque random access memory (STT-RAM), or the like. In the present specification, for convenience of description, the memory device 100 is a NAND flash memory.

The memory device 100 is configured to receive a command and an address from the memory controller 200 and access an area selected by the address of the memory cell array. That is, the memory device 100 may perform an operation instructed by the command on the area selected by the address. For example, the memory device 100 may perform a write operation (program operation), a read operation, and an erase operation. During the program operation, the memory device 100 may program data to the area selected by the address, During the read operation, the memory device 100 may read data from the area selected by the address. During the erase operation, the memory device 100 may erase data stored in the area selected by the address.

The memory device 100 may include a main region including a plurality of data blocks and a buffer region including a plurality of buffer blocks. The buffer blocks may include memory cells storing n bits, where n is a natural number greater than or equal to 1. The data blocks may include memory cells storing m bits, where m is a natural number greater than n.

The main region may be divided into a plurality of zones. At least one or more data blocks may be allocated to each of the plurality of zones. Write data corresponding to consecutive logical addresses may be stored in each zone. The consecutive logical addresses may be mapped to physical addresses of storage units within each of the data blocks allocated to each zone. Data stored in each zone may be managed in a block mapping method.

The memory controller 200 controls an overall operation of the storage device 50.

When power is applied to the storage device 50, the memory controller 200 may execute firmware FW. When the memory device 100 is a flash memory device, the memory controller 200 may operate firmware such as a flash translation layer (FTL) for controlling communication between the host 300 and the memory device 100.

In an embodiment, the memory controller 200 may receive data and a logical block address (LBA) from the host 300 and convert the logical block address RBA) into a physical block address (PBA) indicating an address of memory cells in which data included in the memory device 100 is to be stored.

The memory controller 200 may control the memory device 100 to perform the program operation, the read operation, or the erase operation in response to a request of the host 300. During the program operation, the memory controller 200 may provide a write command, a physical block address, and data to the memory device 100. During the read operation, the memory controller 200 may provide a read command and the physical block address to the memory device 100. During the erase operation, the memory controller 200 may provide an erase command and the physical block address to the memory device 100.

In an embodiment, the memory controller 200 may generate and transmit the command, the address, and the data to the memory device 100 regardless of the request from the host 300. For example, the memory controller 200 may provide the command, the address, and the data to the memory device 100 to perform background operations such as a program operation for wear leveling and a program operation for garbage collection.

In an embodiment, the memory controller 200 may control at least two memory devices 100. In this case, the memory controller 200 may control the memory devices 100 according to an interleaving method to improve operation performance. The interleaving method may be an operation method for overlapping operation periods of at least two memory devices 100.

In an embodiment, the memory controller 200 may control the memory device 100 to flush write data corresponding to a write operation to the buffer block when the write operation performed on a first zone among the plurality of zones is stopped due to a sudden power off in which power supply is abnormally cut off. The memory controller 200 may control the memory device 100 to perform a sudden power off recovery operation of copying data stored in the first zone to a second zone among the plurality of zones after the power supply is restored.

In the sudden power off recovery operation, the memory controller 200 may control the memory device 100 to copy data stored in a source block on which the write operation is stopped among the data blocks allocated to the first zone to a target block among the data blocks allocated to the second zone. The memory controller 200 may control the memory device 100 to copy the write data flushed to the buffer block to the target block. The data stored in the source block and the data flushed to the buffer block may correspond to the consecutive logical addresses.

In an embodiment, the memory controller 200 may include a power manager 210, a flush controller 220, and a sudden power off recovery controller 230.

The power manager 210 may generate a power failure signal when sensing the sudden power off. In an embodiment, the power manager 210 may determine that the sudden power off occurs when power supplied to the storage device 50 is abnormally cut off or a level of the power supplied to the storage device 50 is lower than a reference level during a time equal to or longer than a reference time.

The flush controller 220 may control the memory device 100 to flush the write data corresponding to the write operation to the buffer block in response to the power failure signal. In an embodiment, the data flushed to the buffer block may be write data of which a program in the source block is not completed among the write data corresponding to the write operation.

The sudden power off recovery controller 230 may control the memory device 100 to perform the sudden power off recovery operation after the power supply is restored.

For example, the sudden power recovery controller 230 may control the memory device 100 to copy the data stored in the data blocks allocated to the first zone to the data blocks allocated to the second zone in the sudden power recovery operation.

The sudden power off recovery controller 230 may recover meta data corresponding to the data blocks allocated to the first zone. The meta data may include mapping data including a mapping relationship between a logical address and a physical address, and journal data including a change history of a physical address corresponding to a logical address.

The sudden power off recovery controller 230 may detect the source block of which the write operation is stopped due to the sudden power off among the data blocks allocated to the first zone based on the meta data.

The sudden power off recovery controller 230 may control the memory device 100 to copy the data stored in the source block on which the write operation is stopped among the data blocks allocated to the first zone to the target block among the data blocks allocated to the second zone. After the data stored in the source block is copied to the target block, the sudden power off recovery controller 230 may control the memory device 100 to continuously copy the write data flushed to the buffer block to the target block.

The sudden power off recovery controller 230 may control the memory device 100 to perform the sudden power off recovery operation as a foreground operation. The sudden power off recovery controller 230 may control the memory device 100 to perform the sudden power off recovery operation as a background operation when the memory device 100 is in an idle state in which the memory device 100 does not perform an operation according to the request of the host 300.

The host 300 may communicate with the storage device 50 using at least one of various communication standards or interfaces such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), and a load reduced DIMM (LRDIMM).

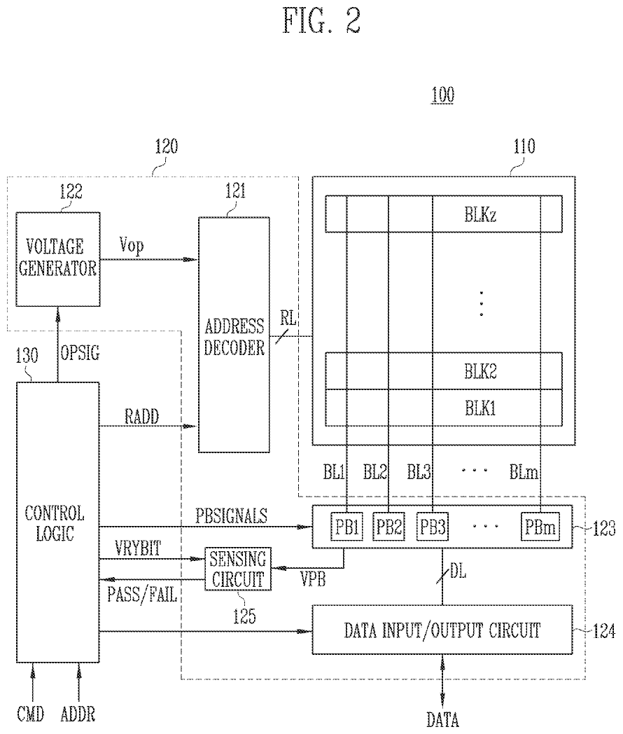

FIG. 2 is a diagram illustrating a structure of the memory device of FIG. 1 according to an embodiment of the present disclosure.

Referring to FIG. 2, the memory device 100 may include a memory cell array 110, a peripheral circuit 120, and a control logic 130.

The memory cell array 110 includes a plurality of memory blocks BLK1 to BLKz. The plurality of memory blocks BLK1 to BLKz are connected to an address decoder 121 through row lines RL. The plurality of memory blocks BLK1 to BLKz are connected to a read and write circuit 123 through bit lines BL1 to BLm. Each of the plurality of memory blocks BLK1 to BLKz includes a plurality of memory cells. In an embodiment, the plurality of memory cells are nonvolatile memory cells. Memory cells connected to the same word line among the plurality of memory cells are defined as one physical page. That is, the memory cell array 110 is configured of a plurality of physical pages. According to an embodiment of the present disclosure, each of the plurality of memory blocks BLK1 to BLKz included in the memory cell array 110 may include a plurality of dummy cells. At least one of the dummy cells may be connected in series between a drain select transistor and the memory cells, and between a source select transistor and the memory cells.

Each of the memory cells of the memory device 100 may be configured as an SLC that stores one data bit, an MLC that stores two data bits, a TLC that stores three data bits, or a QLC that stores four data bits.

The peripheral circuit 120 may include an address decoder 121, a voltage generator 122, the read and write circuit 123, a data input/output circuit 124, and a sensing circuit 125.

The peripheral circuit 120 drives the memory cell array 110. For example, the peripheral circuit 120 may drive the memory cell array 110 to perform a program operation, a read operation, and an erase operation.

The address decoder 121 is connected to the memory cell array 110 through the row lines RL. The row lines RL may include drain select lines, word lines, source select lines, and a common source line. According to an embodiment of the present disclosure, the word lines may include normal word lines and dummy word lines. According to an embodiment of the present disclosure, the row lines RL may further include a pipe select line.

The address decoder 121 is configured to operate in response to control of the control logic 130, The address decoder 121 receives an address ADDR from the control logic 130.

The address decoder 121 is configured to decode a block address of the received address ADDR. The address decoder 121 selects at least one memory block among the memory blocks BLK1 to BLKz according to the decoded block address. The address decoder 121 is configured to decode a row address of the received address ADDR. The address decoder 121 may select at least one word line among word lines of a selected memory block according to the decoded address. The address decoder 121 may apply an operation voltage Vop received from the voltage generator 122 to the selected word line.

During the program operation, the address decoder 121 may apply a program voltage to a selected word line and apply a pass voltage having a level less than that of the program voltage to unselected word lines. During a program verify operation, the address decoder 121 may apply a verify voltage to the selected word line and apply a verify pass voltage having a level greater than that of the verify voltage to the unselected word lines.

During the read operation, the address decoder 121 may apply a read voltage to the selected word line and apply a read pass voltage having a level greater than that of the read voltage to the unselected word lines.

According to an embodiment of the present disclosure, the erase operation of the memory device 100 is performed in a unit of a memory block. The address ADDR input to the memory device 100 during the erase operation includes a block address. The address decoder 121 may decode the block address and select at least one memory block according to the decoded block address. During the erase operation, the address decoder 121 may apply a ground voltage to the word lines input to the selected memory block.

According to an embodiment of the present disclosure, the address decoder 121 may be configured to decode a column address of the transferred address ADDR. The decoded column address may be transferred to the read and write circuit 123. As an example, the address decoder 121 may include a component such as a row decoder, a column decoder, and an address buffer.

The voltage generator 122 is configured to generate a plurality of operation voltages Vop by using an external power voltage supplied to the memory device 100. The voltage generator 122 operates in response to the control of the control logic 130.

As an embodiment, the voltage generator 122 may generate an internal power voltage by regulating the external power voltage. The internal power voltage generated by the voltage generator 122 is used as an operation voltage of the memory device 100.

As an embodiment, the voltage generator 122 may generate the plurality of operation voltages Vop using the external power voltage or the internal power voltage. The voltage generator 122 may be configured to generate various voltages required by the memory device 100. For example, the voltage generator 122 may generate a plurality of erase voltages, a plurality of program voltages, a plurality of pass voltages, a plurality of selection read voltages, and a plurality of non-selection read voltages.

In order to generate the plurality of operation voltages Vop having various voltage levels, the voltage generator 122 may include a plurality of pumping capacitors that receive the internal voltage and selectively activate the plurality of pumping capacitors in response to the control logic 130 to generate the plurality of operation voltages Vop.

The plurality of generated operation voltages Vop may be supplied to the memory cell array 110 by the address decoder 121.

The read and write circuit 123 includes first to m-th page buffers PB1 to PBm. The first to m-th page buffers PB1 to PBm are connected to the memory cell array 110 through first to m-th bit lines BL1 to BLm, respectively. The first to m-th page buffers PB1 to PBm operate in response to the control of the control logic 130.

The first to m-th page buffers PB1 to PBm communicate data DATA with the data input/output circuit 124. At a time of program, the first to m-th page buffers PB1 to PBm receive the data DATA to be stored through the data input/output circuit 124 and data lines DL.

During the program operation, when a program voltage is applied to the selected word line, the first to m-th page buffers PB1 to PBm may transfer the data DATA to be stored, that is, the data DATA received through the data input/output circuit 124 to the selected memory cells through the bit lines BL1 to BLm. The memory cells of the selected page are programmed according to the transferred data DATA. A memory cell connected to a bit line to which a program permission voltage (for example, a ground voltage) is applied may have an increased threshold voltage. A threshold voltage of a memory cell connected to a bit line to which a program inhibition voltage (for example, a power voltage) is applied may be maintained. During the program verify operation, the first to m-th page buffers PB1 to PBm read the data DATA stored in the memory cells from the selected memory cells through the bit lines BL1 to BLm.

During the read operation, the read and write circuit 123 may read the data DATA from the memory cells of the selected page through the bit lines BL and store the read data DATA in the first to m-th page buffers PB1 to PBm.

During the erase operation, the read and write circuit 123 may float the bit lines BL. In an embodiment, the read and write circuit 123 may include a column selection circuit.

The data input/output circuit 124 is connected to the first to m-th page buffers PB1 to PBm through the data lines DL. The data input/output circuit 124 operates in response to the control of the control logic 130.

The data input/output circuit 124 may include a plurality of input/output buffers (not shown) that receive input data DATA. During the program operation, the data input/output circuit 124 receives the data DATA to be stored from an external controller (not shown). During the read operation, the data input/output circuit 124 outputs the data DATA transferred from the first to m-th page buffers PB1 to PBm included in the read and write circuit 123 to the external controller.

During the read operation or the verify operation, the sensing circuit 125 may generate a reference current in response to a signal of a permission bit VRYBIT generated by the control logic 130 and may compare a sensing voltage VPB received from the read and write circuit 123 with a reference voltage generated by the reference current to output a pass signal or a fail signal to the control logic 130.

The control logic 130 may be connected to the address decoder 121, the voltage generator 122, the read and write circuit 123, the data input/output circuit 124, and the sensing circuit 125. The control logic 130 may be configured to control all operations of the memory device 100. The control logic 130 may operate in response to a command CMD transferred from an external device.

The control logic 130 may generate various signals in response to the command CMD and the address ADDR to control the peripheral circuit 120. For example, the control logic 130 may generate an operation signal OPSIG, the address ADDR, a read and write circuit control signal PBSIGNALS, and the permission bit VRYBIT in response to the command CMD and the address ADDR. The control logic 130 may output the operation signal OPSIG to the voltage generator 122, output the address ADDR to the address decoder 121, output the read and write control signal to the read and write circuit 123, and output the permission bit VRYBIT to the sensing circuit 125. In addition, the control logic 130 may determine whether the verify operation is passed or failed in response to the pass or fail signal PASS/FAIL output by the sensing circuit 125.

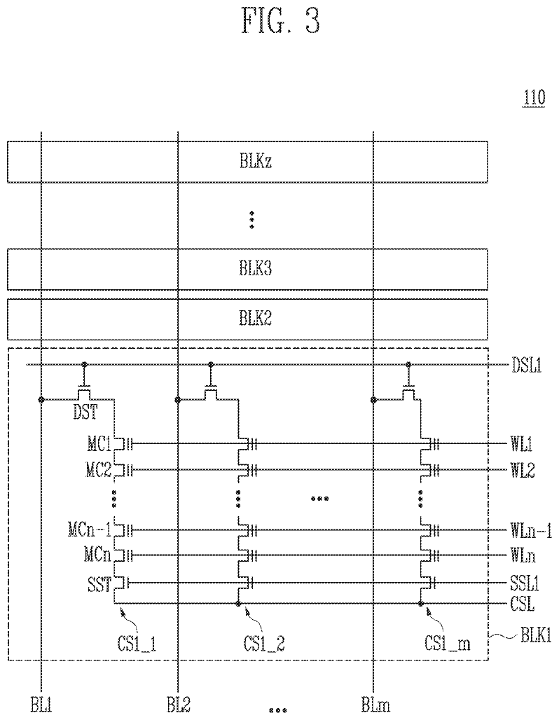

FIG. 3 is a diagram illustrating the memory cell array of FIG. 2 according to an embodiment of the present disclosure.

Referring to FIG. 3, the first to z-th memory blocks BLK1 to BLKz are commonly connected to the first to n-th bit lines BL1 to BLm. In FIG. 3, for convenience of description, elements included in the first memory block BLK1 of the plurality of memory blocks BLK1 to BLKz are shown, and elements included in each of the remaining memory blocks BLK2 to BLKz are omitted. It will be understood that each of the remaining memory blocks BLK2 to BLKz is configured similarly to the first memory block BLK1.

The memory block BLK1 may include a plurality of cell strings CS1_1 to CS1_m, where m is a positive integer. The first to m-th cell strings CS1_1 to CS1_m are connected to the first to m-th bit lines BL1 to BLm, respectively. Each of the first to m-th cell strings CS1_1 to CS1_m includes a drain select transistor DST, a plurality of memory cells MC1 to MCn connected in series, where n is a positive integer, and a source select transistor SST.

Gate terminals of the drain select transistors DST included in each of the first to m-th cell strings CS1_1 to CS1_m are connected to a drain select line DSL1. Gate terminals of the first to n-th memory cells MC1 to MCn included in each of the first to m-th cell strings CS1_1 to CS1_m are connected to the first to n-th word lines WL1 to WLn, respectively. Gate terminals of the source select transistors SST included in each of the first to m-th cell strings CS1_1 to CS1_m are connected to a source select line SSL1.

For convenience of description, a structure of the cell string will be described with reference to the first cell string CS1_1 of the plurality of cell strings CS1_1 to CS1_m. However, it will be understood that each of the remaining cell strings CS1_2 to CS1_m is configured similarly to the first cell string CS1_1.

A drain terminal of the drain select transistor DST included in the first cell string CS1_1 is connected to the first bit line BL1. A source terminal of the drain select transistor DST included in the first cell string CS1_1 is connected to a drain terminal of the first memory cell MC1 included in the first cell string CS1_1. The first to n-th memory cells MC1 to MCn are connected in series with each other. A drain terminal of the source select transistor SST included in the first cell string CS1_1 is connected to a source terminal of the n-th memory cell MCn included in the first cell string CS1_1. A source terminal of the source select transistor SST included in the first cell string CS1_1 is connected to a common source line CSL. In an embodiment, the common source line CSL may be commonly connected to the first to z-th memory blocks BLK1 to BLKz.

The drain select line DSL1, the first to n-th word lines WL1 to WLn, and the source select line SSL1 are included in row lines RL of FIG. 2. The drain select line DSL1, the first to n-th word lines WL1 to WLn, and the source select line SSL1 are controlled by the address decoder 121. The common source line CSL is controlled by the control logic 130. The first to m-th bit lines BL1 to BLm are controlled by the read and write circuit 123.

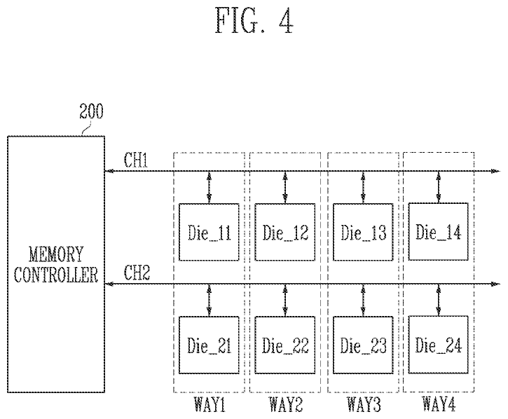

FIG. 4 is a diagram illustrating a method in which one memory controller controls a plurality of memory devices according to an embodiment of the present disclosure.

Referring to FIG. 4, the memory controller 200 may be connected to a plurality of memory devices Die_11 to Die_24 through a first channel CH1 and a second channel CH2. The number of channels or the number of memory devices connected to each channel is not limited to the present embodiment.

The memory devices Die_11 to Die_14 may be commonly connected to the first channel CH1. The memory devices Die_11 to Die_14 may communicate with the memory controller 200 through the first channel CH1.

Since the memory devices Die_11 to Die_14 are commonly connected to the first channel CH1, only one memory device may communicate with the memory controller 200 at a time. However, internal operations of each of the memory devices Die_11 to Die_14 may be simultaneously performed.

The memory devices Die_21 to Die_24 may be commonly connected to the second channel CH2. The memory devices Die_21 to Die_24 may communicate with the memory controller 200 through the second channel CH2.

Since the memory devices Die_21 to Die_24 are commonly connected to the second channel CH2, only one memory device may communicate with the memory controller 200 at a time, Internal operations of each of the memory devices Die_21 to Die_24 may be simultaneously performed.

A storage device using a plurality of memory devices may improve performance by using data interleaving which is data communication using an interleave method. The data interleaving may be performing a data read operation or a data write operation by moving a way in a structure in which two or more ways share one channel. For the data interleaving, the memory devices may be managed in a unit of a channel and a way. In order to maximize parallelism of the memory devices connected to each channel, the memory controller 200 may disperse consecutive logical memory areas into the channel and the way, and allocate the consecutive logical memory areas.

For example, the memory controller 200 may transmit a command, a control signal including an address, and data to the memory device Die_11 through the first channel CH1. While the memory device Die_11 programs the transmitted data to a memory cell included therein, the memory controller 200 may transmit the command, the control signal including the address, and the data to the memory device Die_12.

In FIG. 4, the plurality of memory devices may be configured of four ways WAY1 to WAY4. The first way WAY1 may include the memory devices Die_11 and Die_21, The second way WAY2 may include the memory devices Die_12 and Die_22. The third way WAY3 may include the memory devices Die_13 and Die_23. The fourth way WAY4 may include the memory devices Die_14 and Die_24.

Each of the channels CH1 and CH2 may be a bus of signals shared and used by the memory devices connected to a corresponding channel.

In FIG. 4, the data interleaving in two channel/four way structure is described. However, interleaving may be more efficient as the number of channels and the number of ways increase.

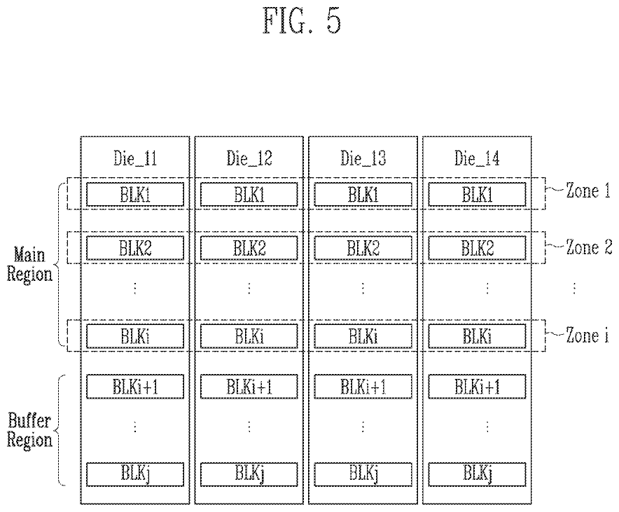

FIG. 5 is a diagram illustrating a zone in which sequential writing is performed according to an embodiment of the present disclosure.

Referring to FIG. 5, each of the plurality of memory devices Die_11 to Die_14 may include a main region including a plurality of data blocks BLK1 to BLKi, where i is a positive integer, and a plurality of buffer blocks BLKi+1 to BIN, where j is a positive integer.

The main region may be divided into a plurality of zones Zone 1 to Zone i. At least one or more data blocks included in different memory devices may be allocated to each zone. In FIG. 5, one data block included in different memory devices may be allocated to each zone. However, the number of data blocks allocated to each zone is not limited to the present embodiment.

Each zone may be a storage area in which sequential writing is performed. Therefore, the write data corresponding to the consecutive logical addresses may be stored in each zone. In each zone, data may be managed in a block mapping method.

The buffer blocks BLKi+1 to BLKj may include memory cells storing n bits, where n is a natural number greater than or equal to 1. The data blocks BLK1 to BLKi, where i is a positive integer, may include memory cells storing m bits, where m is a natural number greater than n.

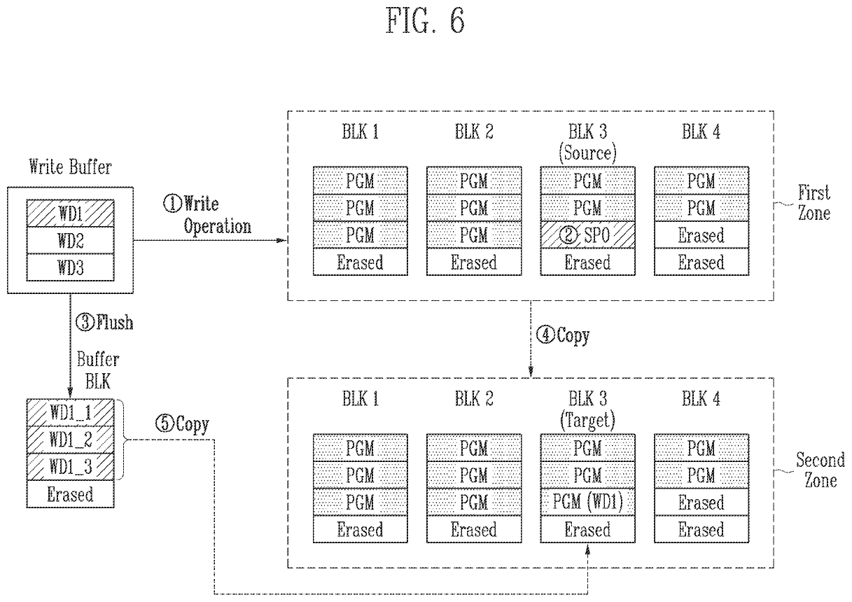

FIG. 6 is a diagram illustrating a sudden power off recovery operation according to an embodiment of the present disclosure.

Referring to FIG. 6, four data blocks BLK 1 to BLK 4 may be allocated to each of the first zone and the second zone. The number of data blocks allocated to each zone is not limited to the present embodiment.

The write buffer of the memory controller 200 described with reference to FIG. 1 may store write data WD1 to WD3 to be stored in the first zone.

A write operation of storing the first write data WD1 in the first zone may be performed. When a sudden power off (SPO) occurs while the first write data WD1 is stored in the data blocks of the first zone, the write operation may be stopped. Among the data blocks allocated to the first zone, the data block BLK 3 on which the write operation is stopped may be the source block.

Among the write data WD1 to WD3 stored in the write buffer, the write data WD1 of which the program in the source block is not completed may be flushed to the buffer block.

In FIG. 6, the buffer block may be an SLC block including an SLC that stores one bit. The data block may be a TLC block including a TLC storing three bits. The number of data bits stored by the memory cell included in the buffer block and the number of data bits stored by the memory cell included in the data block are not limited to the present embodiment.

Thus, the write data WD1 stored in the write buffer is flushed into the buffer block as form of WD1_1 to WD1_3.

When the power supply is restored after the SPO, the sudden power off recovery operation may be performed. In the sudden power off recovery operation, the data stored in the data blocks allocated to the first zone may be copied to the data blocks allocated to the second zone. At this time, the data stored in the source block may be copied to the target block. The target block may be a data block corresponding to the source block of the first zone among the data blocks allocated to the second zone.

In the sudden power off recovery operation, after the data stored in the source block is copied to the target block, the write data WD1_1 to WD1_3 flushed to the buffer block may be copied to the target block. The data stored in the source block and the write data WD1_1 to WD1_3 flushed to the buffer block may correspond to the consecutive logical addresses. After the sudden power off recovery operation is completed, the first zone may be invalidated.

In an embodiment, the sudden power off recovery operation may be performed prior to the operation according to the request of the host, as a foreground operation. In another embodiment, the sudden power off recovery operation may be performed later than the operation according to the request of the host, as a background operation.

According to an embodiment of the present disclosure, even though the SPO occurs during the write operation, continuity and unity of the write data stored in each zone may be maintained.

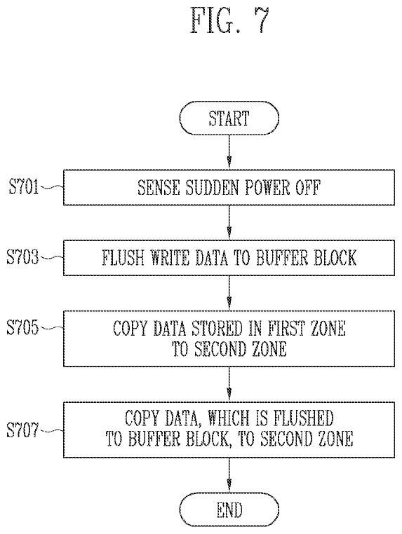

FIG. 7 is a flowchart illustrating an operation of a storage system according to an embodiment of the present disclosure.

Referring to FIG. 7, in operation S701, the storage device may sense the sudden power off while performing the write operation on the first zone among the plurality of zones.

In operation S703, the storage device may flush the write data to the buffer block. The write data may be data in which a program is not completed because the write operation is stopped due to the sudden power off.

In operation S705, the storage device may copy the data stored in the first zone among the plurality of zones to the second zone.

In operation S707, the storage device may copy the write data, which is flushed to the buffer block, to the second zone.

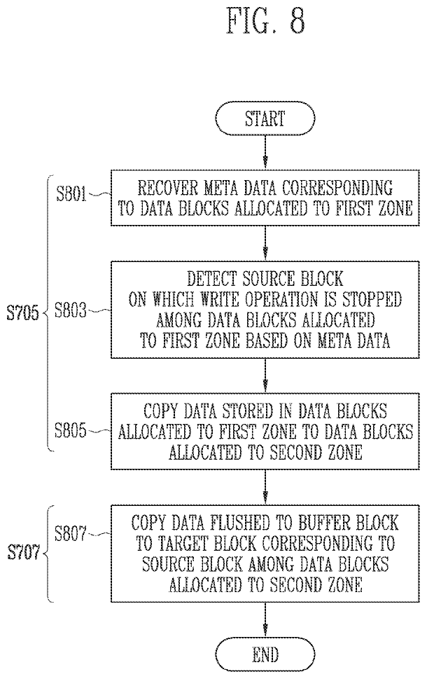

FIG. 8 is a flowchart illustrating in detail the operation of the storage device described with reference to FIG. 7 according to an embodiment of the present disclosure.

Referring to FIG. 8, operation S705 described with reference to FIG. 7 may correspond to operations S801 to S805, and operation S707 may correspond to operation S807.

In operation S801, the storage device may recover the meta data corresponding to the data blocks allocated to the first zone.

In operation S803, the storage device may detect the source block on which the write operation is stopped among the data blocks allocated to the first zone based on the meta data.

In operation S805, the storage device may copy the data stored in the data blocks allocated to the first zone to the data blocks allocated to the second zone.

In operation S807, the storage device may copy the write data, which is flushed to the buffer block, to the target block corresponding to the source block among the data blocks allocated to the second zone.

In various embodiments, an order of operations S803 and S805 may be changed.

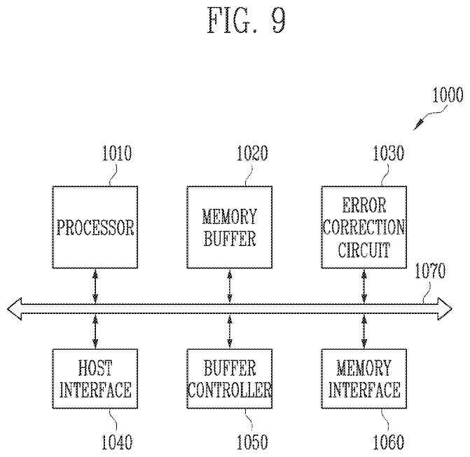

FIG. 9 is a diagram illustrating another embodiment of the present disclosure of the memory controller of FIG. 1.

Referring to FIG. 9, the memory controller 1000 is connected to a host Host and the memory device. The memory controller 1000 is configured to access the memory device in response to the request from the host Host. For example, the memory controller 1000 is configured to control the write, read, erase, and background operations of the memory device. The memory controller 1000 is configured to provide an interface between the memory device and the host Host. The memory controller 1000 is configured to drive firmware for controlling the memory device.

The memory controller 1000 may include a processor 1010, a memory buffer 1020, an error correction circuit (ECC) 1030, a host interface 1040, a buffer control circuit 1050, a memory interface 1060, and a bus 1070.

The bus 1070 may be configured to provide a channel between components of the memory controller 1000.

The processor 1010 may control an overall operation of the memory controller 1000 and may perform a logical operation. The processor 1010 may communicate with an external host through the host interface 1040 and communicate with the memory device through the memory interface 1060. In addition, the processor 1010 may communicate with the memory buffer 1020 through the buffer controller 1050. The processor 1010 may control an operation of the storage device using the memory buffer 1020 as an operation memory, a cache memory, or a buffer memory.

The processor 1010 may perform a function of a flash translation layer (FTL). The processor 1010 may convert a logical block address (LBA) provided by the host into a physical block address (PBA) through the flash translation layer (FTL). The flash translation layer (FTL) may receive the logical block address (LBA) using a mapping table and convert the logical block address (LBA) into the physical block address (PBA). An address mapping method of the flash translation layer may include various methods according to a mapping unit. A representative address mapping method includes a page mapping method, a block mapping method, and a hybrid mapping method.

The processor 1010 is configured to randomize data received from the host Host. For example, the processor 1010 may randomize the data received from the host Host using a randomizing seed. The randomized data is provided to the memory device as data to be stored and is programmed to the memory cell array.

The processor 1010 is configured to de-randomize data received from the memory device during the read operation. For example, the processor 1010 may de-randomize the data received from the memory device using a de-randomizing seed. The de-randomized data may be output to the host Host.

In an embodiment, the processor 1010 may perform the randomization and the de-randomization by driving software or firmware.

The memory buffer 1020 may be used as an operation memory, a cache memory, or a buffer memory of the processor 1010. The memory buffer 1020 may store codes and commands executed by the processor 1010. The memory buffer 1020 may store data processed by the processor 1010. The memory buffer 1020 may include a static RAM (SRAM) or a dynamic RAM (DRAM).

The ECC 1030 may perform error correction. The ECC 1030 may perform error correction encoding (ECC encoding) based on data to be written to the memory device through memory interface 1060. The error correction encoded data may be transferred to the memory device through the memory interface 1060. The ECC 1030 may perform error correction decoding (ECC decoding) on the data received from the memory device through the memory interface 1060. For example, the ECC 1030 may be included in the memory interface 1060 as a component of the memory interface 1060.

The host interface 1040 is configured to communicate with an external host under control of the processor 1010. The host interface 1040 may be configured to perform communication using at least one of various communication standards or interfaces such as a universal serial bus (USB), a serial AT attachment (SATA), a serial attached SCSI (SAS), a high speed interchip (HSIC), a small computer system interface (SCSI), a peripheral component interconnection (PCI express), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), and a load reduced DIMM (LRDIMM).

The buffer controller 1050 is configured to control the memory buffer 1020 under the control of the processor 1010.

The memory interface 1060 is configured to communicate with the memory device under the control of the processor 1010. The memory interface 1060 may communicate a command, an address, and data with the memory device through a channel.

For example, the memory controller 1000 may not include the memory buffer 1020 and the buffer controller 1050.

For example, the processor 1010 may control the operation of the memory controller 1000 using codes. The processor 1010 may load the codes from a nonvolatile memory device for example, a read only memory, provided inside the memory controller 1000. As another example, the processor 1010 may load the codes from the memory device through the memory interface 1060.

For example, the bus 1070 of the memory controller 1000 may be divided into a control bus and a data bus. The data bus may be configured to transmit data within the memory controller 1000 and the control bus may be configured to transmit control information such as a command and an address within the memory controller 1000. The data bus and the control bus may be separated from each other and may not interfere with each other or affect each other. The data bus may be connected to the host interface 1040, the buffer controller 1050, the ECC 1030, and the memory interface 1060. The control bus may be connected to the host interface 1040, the processor 1010, the buffer controller 1050, the memory buffer 1202, and the memory interface 1060.

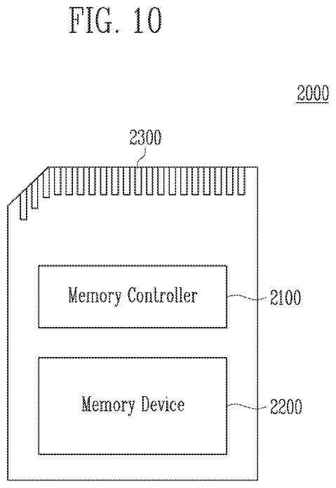

FIG. 10 is a block diagram illustrating a memory card system 2000 to which the storage device according to an embodiment of the present disclosure is applied.

Referring to FIG. 10, the memory card system 2000 includes a memory controller 2100, a memory device 2200, and a connector 2300.

The memory controller 2100 is connected to the memory device 2200. The memory controller 2100 is configured to access the memory device 2200. For example, the memory controller 2100 may be configured to control read, write, erase, and background operations of the memory device 2200, The memory controller 2100 is configured to provide an interface between the memory device 2200 and a host. The memory controller 2100 is configured to drive firmware for controlling the memory device 2200. The memory controller 2100 may be implemented identically to the memory controller 200 described with reference to FIG. 1.

For example, the memory controller 2100 may include components such as a random access memory (RAM), a processor, a host interface, a memory interface, and an ECC.

The memory controller 2100 may communicate with an external device through the connector 2300. The memory controller 2100 may communicate with an external device for example, the host, according to a specific communication standard. For example, the memory controller 2100 is configured to communicate with an external device through at least one of various communication standards such as a universal serial bus (USB), a multimedia card (MMC), an embedded MMC (eMMC), a peripheral component interconnection (PCI), a PCI express (PCI-e or PCIe), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and an NVMe. For example, the connector 2300 may be defined by at least one of the various communication standards described above.

For example, the memory device 2200 may be configured of various nonvolatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), and a spin-torque magnetic RAM (STT-MRAM).

The memory controller 2100 and the memory device 2200 may be integrated into one semiconductor device to configure a memory card. For example, the memory controller 2100 and the memory device 2200 may be integrated into one semiconductor device to configure a memory card such as a PC card (personal computer memory card international association (PCMCIA)), a compact flash card (CF), a smart media card (SM or SMC), a memory stick, a multimedia card (MMC, RS-MMC, MMCmicro, or eMMC), an SD card (SD, miniSD, microSD, or SDRC), and a universal flash storage (UFS).

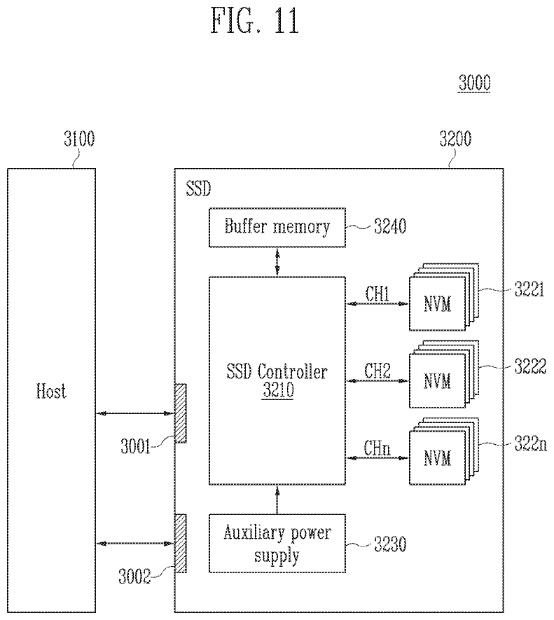

FIG. 11 is a block diagram illustrating a solid state drive (SSD) system 3000 to which the storage device according to an embodiment of the present disclosure is applied.

Referring to FIG. 11, the SSD system 3000 includes a host 3100 and an SSD 3200. The SSD 3200 exchanges a signal SIG with the host 3100 through a signal connector 3001 and receives power PWR through a power connector 3002. The SSD 3200 includes an SSD controller 3210, a plurality of flash memories 3221 to 322n, an auxiliary power device 3230, and a buffer memory 3240.

According to an embodiment of the present disclosure, the SSD controller 3210 may perform the function of the memory controller 200 described with reference to FIG. 1.

The SSD controller 3210 may control the plurality of flash memories 3221 to 322n in response to the signal SIG received from the host 3100. For example, the signal SIG may be signals based on an interface between the host 3100 and the SSD 3200. For example, the signal SIG may be a signal defined by at least one of communication standards or interfaces such as a universal serial bus (USB), a multimedia card (MMC), an embedded MMC (eMMC), a peripheral component interconnection (PCI), a PCI express (PCI-e or PCIe), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and an NVMe.

The auxiliary power device 3230 is connected to the host 3100 through the power connector 3002. The auxiliary power device 3230 may receive the power PWR from the host 3100 and may charge the power. The auxiliary power device 3230 may provide power to the SSD 3200 when the power supply from the host 3100 is not smooth. For example, the auxiliary power device 3230 may be positioned in the SSD 3200 or may be positioned outside the SSD 3200. For example, the auxiliary power device 3230 may be positioned on a main board and may provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or may temporarily store meta data (for example, a mapping table) of the flash memories 3221 to 322n. The buffer memory 3240 may include a volatile memory such as a DRAM, an SDRAM, a DDR SDRAM, an LPDDR SDRAM, and a GRAM, or a nonvolatile memory such as an FRAM, a ReRAM, an STT-MRAM, and a PRAM.

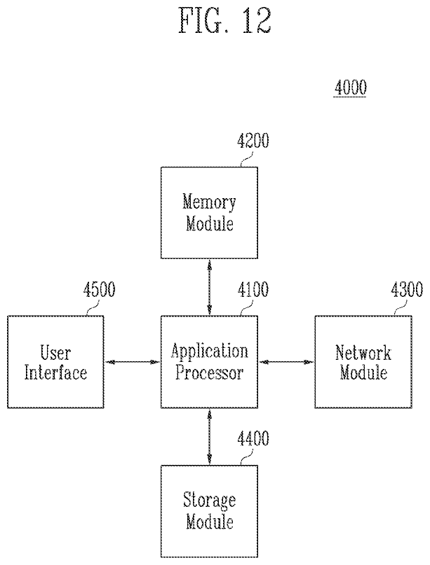

FIG. 12 is a block diagram illustrating a user system to which the storage device according to an embodiment of the present disclosure is applied.

Referring to FIG. 12, the user system 4000 includes an application processor 4100, a memory module 4200, a network module 4300, a storage module 4400, and a user interface 4500.

The application processor 4100 may drive components, an operating system (OS), a user program, or the like included in the user system 4000. For example, the application processor 4100 may include controllers, interfaces, graphics engines, and the like that control the components included in the user system 4000, The application processor 4100 may be provided as a system-on-chip (SoC).

The memory module 4200 may operate as a main memory, an operation memory, a buffer memory, or a cache memory of the user system 4000. The memory module 4200 may include a volatile random access memory such as a DRAM, an SDRAM, a DDR SDRAM, a DDR2 SDRAM, a DDR3 SDRAM, an LPDDR SDARM, an LPDDR2 SDRAM, and an LPDDR3 SDRAM, or a nonvolatile random access memory, such as a PRAM, a ReRAM, an MRAM, and an FRAM. For example, the application processor 4100 and memory module 4200 may be packaged based on a package on package (POP) and provided as one semiconductor package.

The network module 4300 may communicate with external devices. For example, the network module 4300 may support wireless communication such as code division multiple access (CDMA), global system for mobile communications (GSM), wideband CDMA (WCDMA), CDMA-2000, time division multiple access (TDMA), long term evolution, WiMAX, WLAN, UWB, Bluetooth, and Wi-Fi. For example, the network module 4300 may be included in the application processor 4100.

The storage module 4400 may store data. For example, the storage module 4400 may store data received from the application processor 4100, Alternatively, the storage module 4400 may transmit data stored in the storage module 4400 to the application processor 4100. For example, the storage module 4400 may be implemented as a nonvolatile semiconductor memory element such as a phase-change RAM (PRAM), a magnetic RAM (MRAM), a resistive RAM (RRAM), a NAND flash, a NOR flash, and a three-dimensional NAND flash. For example, the storage module 4400 may be provided as a removable storage device (removable drive), such as a memory card, and an external drive of the user system 4000.

For example, the storage module 4400 may include a plurality of nonvolatile memory devices, and the plurality of nonvolatile memory devices may operate identically to the memory device 100 described with reference to FIG. 1. The storage module 4400 may operate identically to the storage device 50 described with reference to FIG. 1.

The user interface 4500 may include interfaces for inputting data or an instruction to the application processor 4100 or for outputting data to an external device. For example, the user interface 4500 may include user input interfaces such as a keyboard, a keypad, a button, a touch panel, a touch screen, a touch pad, a touch ball, a camera, a microphone, a gyroscope sensor, a vibration sensor, and a piezoelectric element. The user interface 4500 may include user output interfaces such as a liquid crystal display (LCD), an organic light emitting diode (OLED) display device, an active matrix OLED (AMOLED) display device, an LED, a speaker, and a monitor.

While certain embodiments have been described above, it will be understood to those skilled in the art that the embodiments described are by way of example only. Accordingly, the storage system, the memory device, and the memory controller should not be limited based on the described embodiments. Rather, the storage system, the memory device, and the memory controller described herein should only be limited in light of the claims that follow when taken in conjunction with the above description and accompanying drawings. Furthermore, the embodiments may be combined to form additional embodiments.

What is claimed is:

1. A storage device comprising:
a memory device including a buffer block and a plurality of zones each having a plurality of data blocks; and
a memory controller configured to control the memory device to:
flush write data corresponding to a write operation to the buffer block when the write operation performed on a first zone among the plurality of zones is stopped due to a sudden power off, and
perform a sudden power off recovery operation of copying data stored in the first zone to a second zone among the plurality of zones after the power supply is restored,
wherein in the sudden power off recovery operation, the memory controller controls the memory device to:
copy data stored in a source block on which the write operation is stopped among the data blocks within the first zone to a target block among the data blocks within the second zone, and
copy the write data, which is flushed to the buffer block, to the target block.

2. The storage device of claim 1, wherein the data stored in the source block and the write data flushed to the buffer block correspond to consecutive logical addresses.

3. The storage device of claim 1, wherein the memory controller comprises:
a power manager configured to generate a power failure signal when sensing the sudden power off;
a flush controller configured to control the memory device to flush the write data corresponding to the write operation to the buffer block in response to the power failure signal; and
a sudden power off recovery controller configured to control the memory device to perform the sudden power off recovery operation after the power supply is restored.

4. The storage device of claim 3, wherein the flush controller controls the memory device to flush partial write data to the buffer block, the write operation of programming the partial write data to the source block being not completed among the write data corresponding to the write operation.

5. The storage device of claim 3, wherein, in the sudden power off recovery operation, the sudden power off recovery controller is further configured to:
recover meta data corresponding to the data blocks within the first zone, and
detect the source block on which the write operation is stopped among the data blocks within the first zone based on the meta data.

6. The storage device of claim 5, wherein the meta data includes mapping data including a mapping relationship between a logical address and a physical address, and journal data including a change history of a physical address corresponding to a logical address.

7. The storage device of claim 3, wherein the sudden power off recovery controller controls the memory device to perform the sudden power off recovery operation as a background operation when the memory device is in an idle state.

8. The storage device of claim 1, wherein each of the plurality of zones stores data corresponding to consecutive logical addresses.

9. The storage device of claim 8, wherein the consecutive logical addresses are mapped to physical addresses of storage units within each of the data blocks.

10. The storage device of claim 1,
wherein the buffer block includes memory cells each storing n bits, where n is a natural number greater than or equal to 1, and
wherein the plurality of data blocks include memory cells each storing m bits, where m is a natural number greater than n.

11. A method of operating a storage device including a buffer block and a plurality of zones each having a plurality of data blocks, the method comprising:
sensing a sudden power off in which a power supply is abnormally cut off;
flushing write data corresponding to a write operation to the buffer block when the write operation performed on a first zone among the plurality of zones is stopped due to the sudden power off; and
performing a sudden power off recovery operation of copying data stored in the first zone to a second zone among the plurality of zones after the power supply is restored,
wherein the performing the sudden power off recovery operation comprises:
copying data stored in a source block on which the write operation is stopped among the data blocks within the first zone to a target block among the data blocks within the second zone; and
copying the write data, which is flushed to the buffer block, to the target block.

12. The method of claim 11, wherein the data stored in the source block and the write data flushed to the buffer block correspond to consecutive logical addresses.

13. The method of claim 11,
wherein the sensing the sudden power off comprises generating a power failure signal when sensing the sudden power off, and
wherein the flushing the write data to the buffer block comprises flushing, in response to the power failure signal, the write data corresponding to the write operation to the buffer block.

14. The method of claim 13, wherein the flushing the write data includes flushing partial write data to the buffer block, the write operation of programming the partial write data to the source block being not completed among the write data corresponding to the write operation.

15. The method of claim 11, wherein the performing the sudden power off recovery operation comprises copying data, which is stored in remaining data blocks excluding the source block among the data blocks within the first zone, to remaining data blocks excluding the target block among the data blocks within the second zone.

16. The method of claim 11, wherein the performing the sudden power off recovery operation comprises:
recovering meta data corresponding to the data blocks within the first zone; and
detecting the source block on which the write operation is stopped among the data blocks within the first zone based on the meta data.

17. The method of claim 16, wherein the meta data includes mapping data including a mapping relationship between a logical address and a physical address, and journal data including a change history of a physical address corresponding to a logical address.

18. The method of claim 11,
wherein each of the plurality of zones stores data corresponding to consecutive logical addresses, and
wherein the consecutive logical addresses are mapped to physical addresses of storage units within each of the data blocks.

19. The method of claim 11,
wherein the buffer block includes memory cells each storing n bits, where n is a natural number greater than or equal to 1, and
wherein the plurality of data blocks include memory cells each storing m bits, where m is a natural number greater than n.

20. An operating method of a storage device, the operating method comprising:
flushing target data from a write buffer to a buffer block, a write operation to store the target data into a first block being interrupted due to a sudden power off; and
moving, when powered on after the sudden power off, stored data from the first block to a second block and then the flushed target data from the buffer block to the second block,
wherein the stored data and the target data correspond to consecutive logical addresses.
